(19) United States
(12) Patent Application Publication
(10) Pub. No.: US 2003/0174313 A1
(43) Pub. Date: Sep. 18, 2003

(54) Method and apparatus for testing optical devices

(76) Inventors: Gang He, Quebec City (CA); William S. Gornall, Fairport, NY (US)

Correspondence Address: Law Office of Thomas R. Fitzgerald, Suite 210, 16 East Main Street, Rochester, NY, 14614, US

(21) Appl. No.: 10/389,450

(22) Filed: Mar. 14, 2003

Related U.S. Application Data
(60) Provisional application No. 60/364,110, filed on Mar. 15, 2002.

(51) Int. Cl. G01N 21/00

(52) U.S. Cl. 356/73.1

(57) ABSTRACT

An output optical receiver is equipped with an array of multimode optical fibers. Each multimode fiber has a core size or core diameter that is much larger than the width of the output ports of the waveguide device. The multimode fibers are spaced apart such that each fiber only receives light from one output port. Each multimode fiber is coupled to an optical power meter. The optical power meter measures the intensity of the optical signal received by the multimode fiber. The optical signal can be provided by a broadband optical signal source or wavelength tunable laser coupled to an input fiber aligned to the input port of the waveguide device. The output optical receiver is also equipped with a cross hair sight and camera to assist in aligning the receiver with the waveguide device.

This application claims priority from U.S. Provisional patent application No. 60/364,110 filed Mar. 15, 2002.

### FIELD OF THE INVENTION

The present invention relates to the field of optical device testing and is especially, but not exclusively, applicable to a method and apparatus for testing optical devices at an early stage of their manufacture.

### BACKGROUND TO THE INVENTION

The increasing use of optical technology in the telecommunications infrastructure of both private and public organizations has led to an increased demand for optical devices. While the optical devices themselves, such as optical multiplexers/demultiplexers which use arrayed waveguide gratings (AWGs), can be manufactured at acceptable rates, these manufactured devices need to be tested to ensure that they meet the required specifications. Unfortunately, testing techniques have not kept pace with this demand.

Lithographic techniques are widely used to create integrated optical circuits on wafers, similar to electrical integrated circuits. Usually, many optical devices are fabricated on a single wafer in a pattern that allows access to their input and output ports when the wafer is cut into strips. The input and output ports are usually on opposite edges, or on the same edge, of the wafer strip. The paths followed by the light travelling between the input and output ports typically are rectangular optical waveguides that are a few micrometers in width and height.

The preferred approach to testing the performance of these optical devices is to test as many performance parameters as possible while the devices are on the wafer strips. Common parameters to be measured are insertion loss (the attenuation of light passing through the device), and polarization dependent loss (the variation in the attenuation for different polarizations of the light), as a function of wavelength. Typically, these tests are performed by coupling power meters to the output port(s) of the device and introducing light from a suitable source, e.g., a tunable laser source at an input port. The intensity of the light received at each of the one or more output ports after traversing the corresponding channel or rectangular optical waveguide is recorded as the laser wavelength is scanned.

For these measurements to be representative of the performance of the fully packaged optical device with the input and output fibers attached to the relevant ports, it is important to couple light efficiently into the optical device and to collect substantially all of the light emitted from the output ports. Accordingly, any extraneous losses at the input and output couplings must be minimized. Because the cross sectional area of each of the input and output ports of the optical device is small, alignment of the test equipment with these input and output ports, each of which is about 5 micrometers in width, is critical. It is known to align single mode fibers, having a core diameter of about 9 micrometers, carefully with the input and output ports using high precision, multiple axis alignment stages before any testing is initiated. Such difficult and time consuming processes are incompatible with the needs of high volume manufacturing. It would therefore be advantageous if methods or apparatus that can improve the speed of the alignment process could be found.

It is an object of the present invention to overcome or at least mitigate the disadvantages of the prior art or provide an alternative.

### SUMMARY OF THE INVENTION

According to one aspect of the invention, there is provided a method of testing an optical device having an input port and an output port interconnected by an optical path within the device, the device to be tested by passing optical test signals through the device via said path, the method comprising the steps of:

(i) aligning with said output port a reception port having an effective cross sectional size significantly greater than the cross sectional size of the output port such that a substantial portion of light leaving said output port will be received by the reception port and conveyed to measuring means connected thereto;

(ii) positioning input optical means adjacent to said input port;

(iii) transmitting an optical signal from said input optical means into said input port;

(iv) measuring the signal strength of the corresponding optical signal received by said reception port; and

(v) adjusting the positioning of the input optical means relative to the input port so as to maximize the measured signal strength.

According to a second aspect of the invention, there is provided apparatus for testing an optical device having an input port and an output port interconnected by an optical path within the device, the device to be tested by passing optical test signals through the device via said path, the apparatus comprising:

first support means for supporting said optical device;

second support means for positioning adjacent to said input port of said supported optical device input optical means for transmitting an optical signal into said input port;

third support means for supporting a reception port in alignment with a said output port of said optical device supported by the first support means, the reception port having an effective cross sectional size significantly greater than the cross sectional size of the output port such that at least a substantial portion of light leaving said output port will be received by the reception port;

measuring means coupled to the reception port for measuring the signal strength of a corresponding optical signal received by said reception port; and

means for adjusting the positioning of the input optical means relative to the input port.

According to a third aspect of the invention, there is provided a method of testing a plurality of optical devices fabricated on a common substrate, each optical device having an input port and a plurality of output ports each connected to the input port by a corresponding optical path, each device to be tested by passing optical test signals through the device via said paths, the method comprising the steps of:

(i) for a first of the optical devices, aligning with said output port a reception port having an effective cross sectional size significantly greater than the cross sectional size of the output port such that a substantial portion of light leaving said output port will be received by the reception port;

(ii) positioning input optical means adjacent to said input port;

(iii) transmitting an optical signal from said input optical means via said input port and path and measuring the signal strength of the corresponding optical signal received by said reception port;

(iv) adjusting the positioning of the input optical means relative to the input port so as to maximize the measured signal strength;

(v) testing the first optical device by passing said optical test signals through the device, via the input optical means, and performing test measurements upon the corresponding optical test signals received by the reception ports;

(vi) indexing the substrate to position each of the remaining optical devices in turn between the input optical means and reception ports, and

(vii) repeating steps (i) through (v) for each of the remaining optical devices.

According to a fourth aspect of the invention, there is provided apparatus for testing an optical device having an input port and a plurality of output ports each coupled to the input port by a respective one of a plurality of optical paths within the device, the apparatus comprising:

a plurality of reception ports each for receiving an optical signal from a respective one of the plurality of output ports, each reception port having a cross sectional size significantly larger than a cross sectional size of a corresponding one of the plurality of output ports;

optical signal measuring means coupled to the reception ports to receive optical signals therefrom; and

alignment means for registering the plurality of reception ports with the plurality of output ports, respectively;

the arrangement being such that, when the plurality of reception ports are each aligned with the corresponding one of the output ports, each of the reception ports will receive at least a substantial portion of the optical signal from the corresponding one of the output ports, and substantially none of the optical signals from other output ports.

In a preferred embodiment of the invention in which the optical device has a plurality of output ports, the reception ports comprise an array of multimode optical fibers. Each multimode fiber has a core size or core diameter that is much larger than the width of the output ports of the optical device. The multimode fibers are spaced apart such that each fiber only receives light from one output port. Each multimode fiber is coupled to an optical power meter. The optical power meter measures the intensity of the optical signal received by the multimode fiber. The optical signal can be provided by a broadband optical signal source coupled to an input fiber aligned to the input port of the optical device. The reception port(s) may be mounted in fixed relationships to a sight having a datum to assist in aligning the reception port with the output port of the optical device, either by sighting upon the output port and then translating the device by a distance corresponding to a spacing between the sight datum and the reception port, or by sighting upon a fiducial mark on the optical device, the spacing between the fiducial mark and the output port corresponding to the spacing between the sight datum and the reception port.

### BRIEF DESCRIPTION OF THE DRAWINGS

A better understanding of the invention will be obtained by considering the following detailed description of a preferred embodiment which is described, by way of example only, with reference to the following drawings, in which:

FIG. 1 is a schematic view of an apparatus for testing optical devices during manufacture;

FIG. 2 is a front end-view of an output optical receiver used in the apparatus of FIG. 1; and

FIG. 3 is a schematic overlay superimposing multimode fibers of the optical receiver with output ports of the optical device.

### DETAILED DESCRIPTION

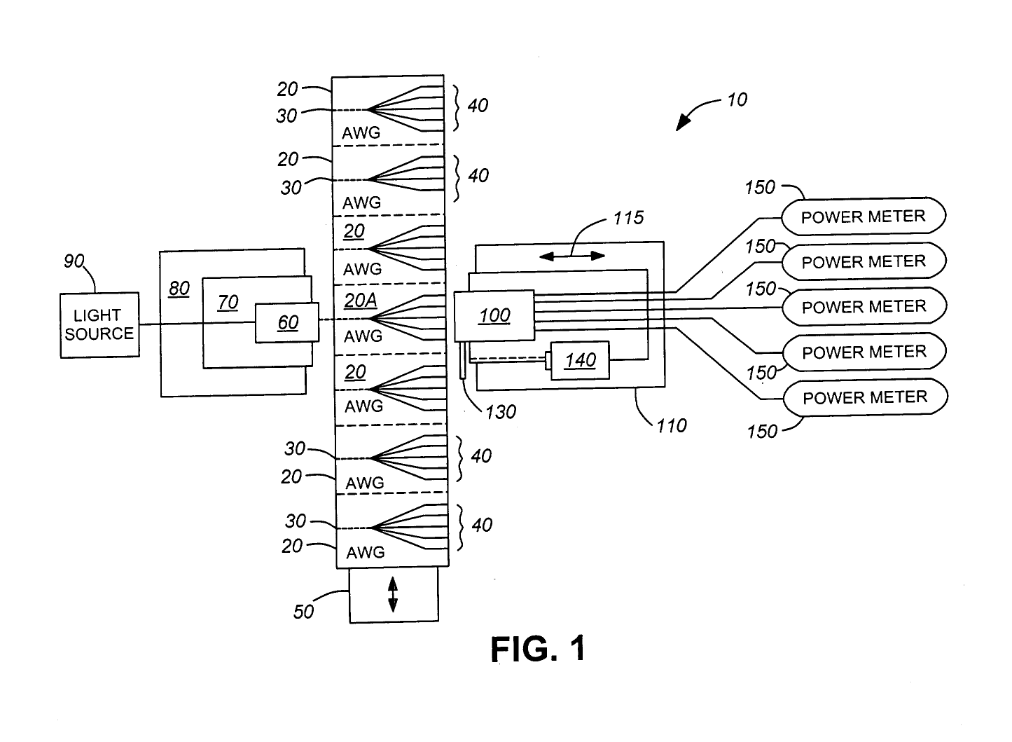

Referring to FIG. 1, apparatus 10 for testing optical devices 20 is illustrated. The optical devices 20, in this case arrayed waveguide gratings (AWGs), are formed out of a single wafer strip prior to being divided into separate devices. Each optical device 20 has an input port 30 and a plurality of output ports 40 each connected to the input port 30 by a respective optical path within the device. The wafer strip is carried on a motorized stage 50 similar to a conveyor belt. An input fiber 60 is mounted on an adjustable platform 70 that is, in turn, carried by a robotic platform 80 capable of adjusting a position of the input fiber 60 along any one of the six axes. These axes are the generally accepted 3 Cartesian coordinates axes (x, y, and z axes) and the 3 attitude axes (roll, pitch, yaw). The input fiber 60 is coupled to a broadband optical signal source 90. The input fiber 60 is placed adjacent to an input port 30 of an optical device 20A to be tested.

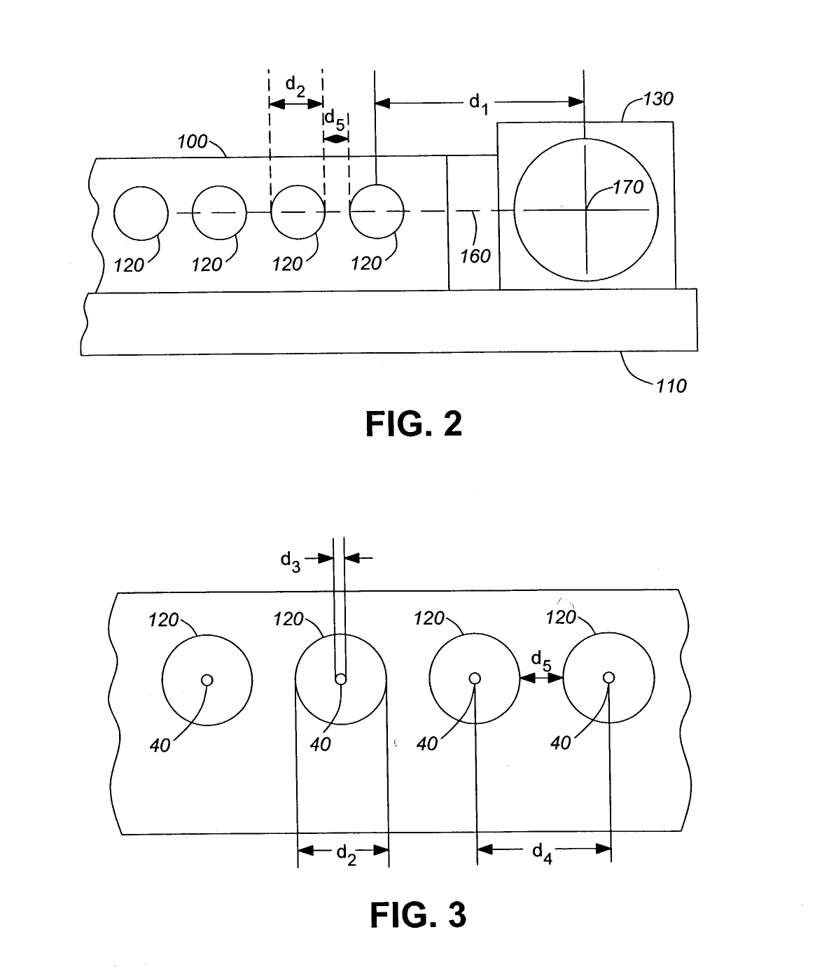

On the other side of the optical device 20A to be tested, an output optical receiver unit 100 is mounted on a movable stage 110. The output optical receiver unit 100 is equipped with multimode fibers 120 (see FIG. 2) arranged in an array. As can be seen from FIG. 3, the spacing or pitch between the multi-mode fibers 120 is the same as the spacing or pitch between the output ports 40. The receiver 100 is also equipped with a transparent alignment cross-hair sight 130. A video camera 140 is mounted on the movable stage 110 and is focussed on the sight 130. Coupled to each of the fibers 120 is a power meter 150. The movable stage 110 can move the receiver 100 towards or away from the optical device 20, as indicated by arrow 115.

It should be noted that FIG. 1 illustrates a wafer strip containing newly manufactured multiple optical devices. These optical devices 20 are to be individually tested to determine whether they perform according to their design and manufacturing specifications. It is more cost and time effective to perform these tests while the optical devices are still on a single wafer strip. After this testing phase, the wafer strip is to be divided into separate optical devices with the optical devices that have passed the testing phase being packaged into optical device modules. It should also be noted that the spacing, i.e., the pitch, between the output ports 40 on each of the optical devices 20 is precisely measured and known. Furthermore, the dimensions and relative position of each optical device 20 on the wafer strip are precisely known from the lithography process used to fabricate the wafer.

As can be seen from FIG. 2, the multimode fibers 120 are arranged in an array. The fibers 120 are aligned such that the center of each fiber 120 is on a common axis 160. The center 170 of the cross hair sight 130 is also on the common axis 160. A calibrated distance d₁ separates the center 170 of the cross hair sight 130 from the center of the first multimode fiber 120.

Operation of the apparatus to align the input fiber 60 with the input port 30 of a selected optical device begins with aligning the center 170 of the cross hair sight 130 on the first output port 40 of the selected optical device, shown as device 20A in FIG. 1. The alignment of the center 170 to the first output port 40 is accomplished by having an operator view the output port 40 through the transparent cross hair sight 130 using the camera 140. The resulting image will be that of the cross hair image superimposed on the output port 40. The operator can therefore align the center 170 with a center of the output port 40. Since the separation distance d₁ between the center 170 of the cross hair sight 130 and the center of the first multimode fiber 120 is accurately known, simply translating the stage 50 by the distance d₁ along a direction parallel to the center line 160 will align the output ports 40 with the fibers 120. The receiver 100 can then be moved into close contact with the output side of the optical device 20A using the movable stage 110.

It should be noted that the output ports 60 are very small as compared with the reception ports i.e., the ends of the multimode fibers 120 and that these are precisely aligned and dimensioned on the optical device 20. The significant difference in cross-sectional size between the output ports 40 and reception ports on the multimode fibers 120 (the front face of the fibers 120 which actually receive the signal from the output ports) allows the system 10 to function even if the output ports 40 are not exactly aligned with the multimode fibers 120. Registration (also known as one-to-one correspondence between the multimode fibers and the output ports) is sufficient. As long as each multimode fiber receives a substantial portion of light from a corresponding output port and substantially no light from any of the other output ports, the testing system will function. Of course, it is preferable for each multimode fiber to receive all of the light emitting from its corresponding output port for optimum testing results.

After the optical device 20A is in position with its output ports 40 opposite the multimode fibers 120 of the optical receiver 100, the input fiber 60 is aligned with the input port 30 of the optical device 20A to be tested. This is done by well-known means using the adjustable platform 70 and the robotic platform 80 to adjust the orientation and position of the input fiber 60 relative to the input port 30. For this purpose, the broadband laser source 90 is used to generate an optical signal which the input fiber 60 transmits into the input port 30 of the optical device 20A. The power meters detect the corresponding portions of the optical signal received by the multimode fibers 120 and measure the intensity or signal strength. The operator may then adjust the position and orientation of the input fiber 60 relative to the input port 30 so as to maximize the signal strength.

Once the input fiber 60 has been aligned with the input port 30 and the fibers 120 are aligned with the output ports 40, the testing of the optical device is carried out. Depending upon the performance parameters to be measured, the broadband optical signal source 90 may also be used for testing purposes, in which case the broadband test optical signal passes through the input fiber 60 and the optical device 20A to be received by the multimode fibers 120. The characteristics of this optical signal are then measured by the power meters 150 or substitute measuring devices appropriate to the test being carried out. Based on these readings, the performance and the suitability for its desired use of the optical device 20A under test can be determined.

After the tests have been performed on one optical device on the strip, the input fiber 60 and output receiver 100 are retracted slightly and the motorized stage 50 advances the strip precisely such that the next optical device 20 is in alignment with the receiver 100. The receiver 100 is again moved into close contact with the output side of the next optical device 20. The input fiber 60 is then finely aligned with the input port 30 on this next device as described above and testing is executed for this particular optical device.

The broadband optical signal source can be used for general testing purposes such as to determine whether specific output ports are operational or not. However, for more specific testing of the characteristics of the optical device, such as performing wavelength or frequency dependent tests, the optical signal source 90 can be replaced by a tunable laser source. This will allow the optical device to be tested using parameters and conditions under which the optical device will be used in the field. While tunable lasers are useful for wavelength and frequency dependant tests, for tests involving polarization effects, an optical signal source capable of changing its state of polarization may be used.

The multimode fibers 120 should each be large relative to the size of the corresponding output port 40. As an example, favourable results have been obtained for output ports having a diameter of 5 micrometers by using a multimode fiber having a diameter of about 62.5 micrometers. This example is particularly applicable for optical devices that have a spacing of 127 micrometers between output ports.

The dimensions can clearly be seen in FIG. 3 which shows the output ports superimposed on the multimode fibers. As can be seen, a diameter d₂ of the multimode fiber 120 dwarfs the dimension d₃ of the output port. Furthermore, a distance d₄ separates the center of adjacent output ports 40 while a distance d₅ separates the perimeter of adjacent fibers 120. Favourable results have been obtained using the following dimensions:

d₂=62.5 micrometers

d₃=5 micrometers

d₄=127 micrometers

d₅=64.5 micrometers.

While the examples given above for d₂, d₃, and d₄ are typical measurements for the industry, other dimensions may be used. As an example, the value for d₂ may be 50, 62.5 or 100 micrometers as long as the spacing between the fibers 120 and the spacing between the output ports 40 can be accommodated. The fibers 120 should be spaced so that a substantial portion of any signal emitted from a given output port is only received by a corresponding single multimode fiber. A ratio d₄:d₂ greater than 2:1 is recommended. To guarantee that the motorized stage 50 will accurately position the output ports 40 within the diameter of the multimode fibers 120 of receiver 100, d₂ is preferably much greater than d₃. An approximate ratio of 10:1 or greater between the dimensions of the output ports 40 and the core diameter of the multimode fibers 120 has been found to provide acceptable results.

To achieve proper optical coupling between the receiver 100 and the optical device 20A under test, a close separation distance between the two must be achieved. A distance of less than 15 micrometers between the receiver 100 and the optical device 20A, with index matching fluid bridging this gap, provides favourable results. It should be noted that divergence of the optical signal as it travels between the output port 40 and the fiber 120 should not be a concern given the minimal separation distance between the two.

Similar considerations apply to the interface between the input fiber 60 and the input ports 30. For optimum coupling of light, the separation distance is preferably less than 15 micrometers and that the gap is filled with index matching fluid. It is envisaged that, as an alternative approach to aligning the optical receiving means (multi-mode fiber) with the output port, a fiduciary mark could be provided on each optical device, during its fabrication, and spaced from the first output port by the same distance d1 which separates the datum of the sight 130 from the first optical receiver centre. Aligning the datum of the sight with the fiduciary mark would automatically align the multi-mode fibers with the output ports.

It should be appreciated that application of the invention is not limited to AWGs; rather it could be used with any optical device having an input port and an output port interconnected by an optical path within the device.

A person understanding this invention may now conceive of alternative structures and embodiments or variations of the above all of which are intended to fall within the scope of the invention as defined in the claims that follow.

We claim:

1. A method of testing an optical device having an input port and an output port interconnected by an optical path within the device, the device to be tested by passing optical test signals through the device via said path, the method comprising the steps of:
(i) aligning with said output port a reception port having an effective cross sectional size significantly greater than the cross sectional size of the output port such that at least a substantial portion of light leaving said output port will be received by the reception port and conveyed to measuring means connected thereto;
(ii) positioning input optical means adjacent to said input port;
(iii) transmitting an optical signal from said input optical means into said input port;
(iv) measuring the signal strength of the corresponding optical signal received by said reception port; and
(v) adjusting the positioning of the input optical means relative to the input port so as to maximize the measured signal strength.

2. A method according to claim 1, wherein the reception port is mounted upon a support in fixed relationship to a sight having a datum spaced from an optical centre of the reception port by a predetermined distance, and the step of aligning the reception port with the output port comprises the step of aligning the datum with the centre of the output port and then translating the optical receiver means and the optical device one relative to the other by said predetermined distance to bring said reception port into alignment with said output port.

3. A method according to claim 1, wherein the reception port is mounted upon a support in fixed relationship to a sight having a datum spaced from an optical centre of the reception port by a predetermined distance and the optical device has a fiducial mark spaced from the centre of the output port by a distance corresponding to said predetermined distance, and the step of aligning the reception port with the output port comprises aligning the datum with the fiducial mark.

4. A method according to claim 1, wherein the optical device has a plurality of said output ports each connected to said input port by an optical path within the device, and a corresponding plurality of reception ports, each having a cross sectional size significantly larger than the cross sectional size of the corresponding one of the output ports, are positioned in registration with the output ports so as to receive corresponding portions of said optical signal supplied to the input port, the signal strength of at least some of the optical signal portions being measured and maximized by adjusting the positioning of the input optical means.

5. A method according to claim 4, wherein the reception ports are spaced apart at pitch intervals corresponding to pitch intervals between the output ports, and only one of the reception ports is manually aligned with the corresponding one of the output ports.

6. A method according to claim 5, wherein the optical device has a fiducial mark at a predetermined distance from the middle of said one of the output ports and the reception ports are mounted upon a support in fixed relationship to a sight having a datum spaced from the middle of said one of the reception ports by a distance corresponding to said predetermined distance, and the step of aligning said one of the reception ports with the corresponding one of the output ports comprises aligning the datum with the fiduciary mark.

7. A method of testing a plurality of optical devices fabricated on a common substrate, each optical device having an input port and a plurality of output ports each connected to the input port by a corresponding optical path, each device to be tested by passing optical test signals through the device via said paths, the method comprising the steps of:
(i) for a first of the optical devices, aligning with said output port a reception port having an effective cross sectional size significantly greater than the cross sectional size of the output port such that a substantial portion of light leaving said output port will be received by the reception port;
(ii) positioning input optical means adjacent to said input port;
(iii) transmitting an optical signal from said input optical means via said input port and path and measuring the signal strength of the corresponding optical signal received by said reception port;
(iv) adjusting the positioning of the input optical means relative to the input port so as to maximize the measured signal strength;
(v) testing the first optical device by passing said optical test signals through the device, via the input optical means, and performing test measurements upon the corresponding optical test signals received by the reception ports;
(vi) indexing the substrate to position each of the remaining optical devices in turn between the input optical means and reception ports, and
(vii) repeating steps (i) through (v) for each of the remaining optical devices.

8. Apparatus for testing an optical device having an input port and an output port interconnected by an optical path within the device, the device to be tested by passing optical test signals through the device via said path, the apparatus comprising:
first support means for supporting said optical device;
second support means for positioning adjacent to said input port of said supported optical device input optical means for transmitting an optical signal into said input port;
third support means for supporting a reception port in alignment with a said output port of said optical device supported by the first support means, the reception port having an effective cross sectional size significantly greater than the cross sectional size of the output port such that at least a substantial portion of light leaving said output port will be received by the reception port;
measuring means coupled to the reception port for measuring the signal strength of a corresponding optical signal received by said reception port; and
means for adjusting the positioning of the input optical means relative to the input port.

9. Apparatus according to claim 8, further comprising a sight mounted upon said third support means in fixed relationship to the reception port, the sight having a datum spaced from an optical centre of the reception port by a predetermined distance, and translation means for effecting relative movement between the reception port and the first support means, following alignment of the datum with said output port, by a distance corresponding to said predetermined distance.

10. Apparatus according to claim 8, further comprising a sight mounted upon said third support means in fixed relationship to the reception port, the sight having a datum spaced from an optical centre of the reception port by a predetermined distance, the optical device having a fiducial mark spaced from the output port by a distance corresponding to said predetermined distance, such that, when the datum is aligned with the fiducial mark, the reception port will be aligned with the output port.

11. Apparatus for testing an optical device having an input port and a plurality of output ports each coupled to the input port by a respective one of a plurality of optical paths within the device, the apparatus comprising:
a plurality of reception ports each for receiving an optical signal from a respective one of the plurality of output ports, each reception port having a cross sectional size significantly larger than a cross sectional size of a corresponding one of the plurality of output ports;
optical signal measuring means coupled to the reception ports to receive optical signals therefrom; and
alignment means for registering the plurality of reception ports with the plurality of output ports, respectively;
the arrangement being such that, when the plurality of reception ports are each aligned with the corresponding one of the output ports, each of the reception ports will receive at least a substantial portion of the optical signal from the corresponding one of the output ports, and substantially none of the optical signals from other output ports.

12. Apparatus according to claim 11, wherein the reception ports are spaced apart at pitch intervals corresponding to pitch intervals at which the output ports are spaced apart, so that, when one of the reception ports is aligned with a corresponding one of the output ports, each of the remaining reception ports is aligned with the corresponding one of the output ports.

13. Apparatus according to claim 11, wherein each reception port is an end of a multimode optical fiber.

14. Apparatus according to claim 11, wherein the optical signal measuring means comprises a plurality of optical power meters each coupled to a respective one of the plurality of reception ports.

15. Apparatus according to claim 11, wherein each reception port has a cross sectional size larger than a cross sectional size of the corresponding output port by approximately ten times or more.

16. Apparatus according to claim 9, wherein the sight includes a video camera for providing a view of the output port and the datum.

17. Apparatus according to claim 10, wherein the sight includes a video camera for providing a view of the datum and the fiduciary mark.

18. Apparatus for testing an optical device having at least one input port and a plurality of output ports, the apparatus comprising:
an optical signal source;
an input optical device coupled to the optical signal source;
an adjustable platform for adjusting a relative displacement between the input optical device and the optical device being tested;
an output optical device having a plurality of reception ports and alignment means for aligning each of the reception ports with a respective one of the output ports of the optical device being tested; and
a plurality of optical signal measurement means, each optical signal measurement means being coupled to a respective one of the reception ports of the output optical device,
wherein
the adjustable platform is adjustable to align the input optical device with one of the at least one input ports;
the alignment means is arranged to align the output optical device with one of the reception ports, so that other reception ports will be aligned with a corresponding one of the plurality of output ports; and
the input optical device supplies an optical signal to the output optical device and to the optical device being tested such that a signal strength of the optical signal received by at least one of the multiple optical signal receivers is measured by at least one of the optical signal measurement means.

19. Apparatus according to claim 18, wherein the input optical device is a single mode optical fiber.

20. Apparatus according to claim 18, wherein each optical signal receiver is a multimode optical fiber.

21. Apparatus according to claim 18, further comprising a sight movable with the output optical device, the sight having a datum spaced from an optical centre of a reference one of the reception ports by a predetermined distance, and translation means for effecting relative movement between the reception ports and the optical device, following alignment of the datum with said output port, by a distance corresponding to said predetermined distance.

22. Apparatus according to claim 18, further comprising a sight movable with the output optical device, the sight having a datum spaced from an optical centre of a reference one of the reception ports by a predetermined distance, the optical device having a fiducial mark spaced from the output port by a distance corresponding to said predetermined distance, such that, when the datum is aligned with the fiducial mark, the reception port will be aligned with the output port.
